(19) United States
(12) Patent Application Publication
(10) Pub. No.: US 2024/0202422 A1
(43) Pub. Date: Jun. 20, 2024

(54) COMPUTER-READABLE RECORDING MEDIUM, DESIGN SUPPORTING METHOD, AND DESIGN SUPPORTING APPARATUS

(71) Applicant: Fujitsu Limited, Kawasaki-shi (JP)

(72) Inventor: Keisuke NISHIDA, Yokohama (JP)

(73) Assignee: Fujitsu Limited, Kawasaki-shi (JP)

(21) Appl. No.: 18/370,634

(22) Filed: Sep. 20, 2023

(30) Foreign Application Priority Data
Dec. 14, 2022 (JP) 2022-199835

(51) Int. Cl. G06F 30/394

(52) U.S. Cl. CPC G06F 30/394; G06F 2111/20

(57) ABSTRACT

A non-transitory computer readable recording medium having stored therein a design supporting program that causes a computer to execute a process including: generating a wiring model in which a gate and a wiring included between registers are replaced with a resistor and a capacitance, and a via that is arranged across wiring layers between the resistors is replaced with a via resistor; calculating, in the wiring model, a gate delay and a wiring delay for each ratio of the via resistor to the total resistors in a wiring structure between the resistors; and writing the calculated gate delay and wiring delay of each of the ratio in the wiring model in library information relating to circuit design.

### CROSS-REFERENCE TO RELATED APPLICATION(S)

This application is based upon and claims the benefit of priority of the prior Japanese Patent Application No. 2022-199835, filed on Dec. 14, 2022, the entire contents of which are incorporated herein by reference.

### FIELD

The embodiment discussed herein is related to a computer readable recording medium, a design supporting method, and a design supporting apparatus.

### BACKGROUND

In recent years, in the field of large scale integrated circuit (LSI), the performance of a transistor part has been improving due to technological miniaturization. On the other hand, in a wiring part, a resistance has increased due to miniaturization, to cause an increase in delay, and, the improvement in performance has been slowing down. In floor planning during design of such an LSI, a long-distance wiring path, which is an important element, is constituted of wiring delay in its significant portion and, therefore, an influence of increased wiring delay is to be significant. A conventional technique has been known for enabling early estimation of such a wiring delay (for example, Japanese Laid-open Patent Publication Nos. 2011-232933, 11-26588).

However, in the conventional technique described above, there has been a problem that proposing an optimal circuit configuration has become difficult because long-distance transmission by a long-distance wiring path is still difficult with only adjustment made to a wiring layer or L/S, due to an influence of increased wire resistance caused by the technological miniaturization.

For example, as a means to achieve further long-distance transmission, redundant via accommodation, modification of the crosstalk delay effect (miller coupling factor (MCF)), and the like can be considered. However, in the conventional technique, in a library generation phase, a wiring model in which the number of vias and the MCF are uniquely determined is developed, and simulations are performed therewith, to generate a library. Therefore, in a tool execution phase using the library, modification of the number of via and the MCF is disabled. If the number of vias or the MCF are attempted to be modified in the tool execution phase using such a library, it is impractical because the enormous number of simulations are required in the library generation phase.

### SUMMARY

According to an aspect of an embodiment, a non-transitory computer readable recording medium having stored therein a design supporting program that causes a computer to execute a process including: generating a wiring model in which a gate and a wiring included between resistors are replaced with a resistor and a capacitance, and a via that is arranged across wiring layers between the resistors is replaced with a via resistor; calculating, in the wiring model, a gate delay and a wiring delay for each ratio of the via resistor to the total resistors in a wiring structure between the resistors; and writing the calculated gate delay and wiring delay of each of the ratio in the wiring model in library information relating to circuit design.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram explaining an example of an LSI design flow;

FIG. 2 is an explanatory diagram explaining an example of a long-distance wiring path;

FIG. 3 is an explanatory diagram explaining a relationship between the number of gate stages and delay;

FIG. 4A is an explanatory diagram explaining an overview of an entire flow in a conventional technique;

FIG. 4B is an explanatory diagram explaining an overview of an entire flow according to an embodiment;

FIG. 5 is a flowchart illustrating a conventional library generation flow;

FIG. 6 is a flowchart illustrating a conventional tool execution flow;

FIG. 7 is an explanatory diagram explaining an example of a regular via and a redundant via;

FIG. 8 is an explanatory diagram explaining an estimation of wiring delay using an MCF;

FIG. 9 is an explanatory diagram explaining a conventional wiring model and an example of a wiring model according to the embodiment;

FIG. 10 is an explanatory diagram explaining an example of a wiring model;

FIG. 11 is an explanatory diagram explaining an example of a wiring structure;

FIG. 12 is an explanatory diagram explaining an example of an expansion of the wiring model;

FIG. 13 is an explanatory diagram explaining an example of expansion of the wiring model;

FIG. 14 is an explanatory diagram explaining an example of a result of simulation;

FIG. 15 is an explanatory diagram explaining an example of a result of simulation;

FIG. 16 is a block diagram illustrating a functional configuration example of a design supporting apparatus according to the embodiment;

FIG. 17 is a flowchart illustrating a library generation flow of the design supporting apparatus according to the embodiment;

FIG. 18 is an explanatory diagram illustrating a description example of a simulation program with integrated circuit emphasis (SPICE) deck;

FIG. 19 is an explanatory diagram explaining an example of via-ratio-compatible expansion library;

FIG. 20 is a flowchart illustrating a tool execution flow of the design supporting apparatus according to the embodiment;

FIG. 21 is an explanatory diagram explaining an example of a wiring structure;

FIG. 22 is a flowchart illustrating an example of delay calculation of the design supporting apparatus according to the embodiment;

FIG. 23 is an explanatory diagram explaining an example of linear interpolation;

FIG. 24 is an explanatory diagram explaining an example of linear interpolation; and

FIG. 25 is an explanatory diagram explaining an example of a computer configuration.

### DESCRIPTION OF EMBODIMENT(S)

Preferred embodiments of the present invention will be explained with reference to accompanying drawings. In embodiments, an identical reference signs are assigned to components having an identical function, and duplicated explanation will be omitted. The design supporting program, the design supporting method, and the design supporting apparatus explained in the following embodiment are only one example, and are not intended to limit the embodiments. Moreover, respective following embodiments may be combined within a range not causing contradictions.

### Problem in Conventional Technique

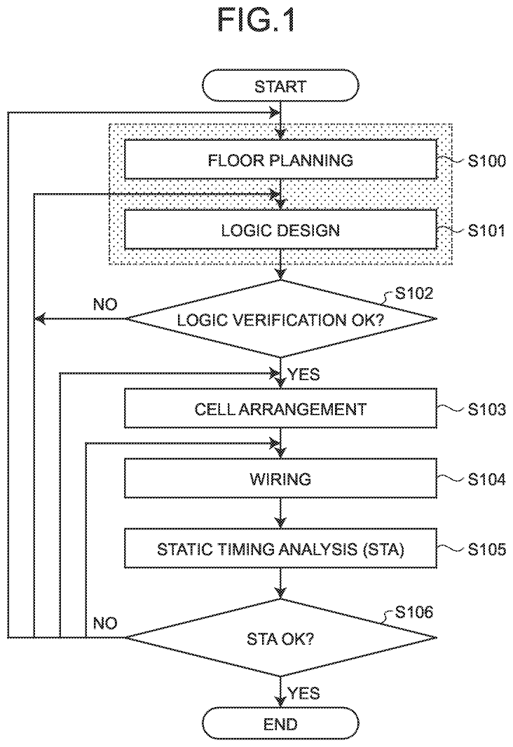

First, a program in a conventional technique will be explained. FIG. 1 is an explanatory diagram explaining an example of an LSI design flow.

As illustrated in FIG. 1, in LSI design, the floor planning, such as determination of a region to which a logical function is allocated on the LSI chip (S100), and logic design (S101) are performed. Subsequently, the designed logic is verified to determine whether the designed logic is OK (the logic is consistent) (step S102). When the logic verification results in not OK (step S102: NO), it is returned to logic design.

When the logic verification results in OK (step S102: YES), wiring is performed based on the floorplan and the logic design (S103, S104), and static timing analysis (STA) is performed (S105).

Subsequently, it is determined whether a result of STA is OK (S106), and when it is not OK (S106: NO), the processing is returned to S103 or the like. When it is OK (S106: YES), an LSI design plan (cell arrangement and wiring based on the floorplan and the logic design) is acquired, and the processing is finished.

To start the floor planning (S100) or the logic design (S101), which are an initial phase of LSI design (hatched part in the drawing), derivation of an optimal circuit configuration of a long-distance wiring path becomes important.

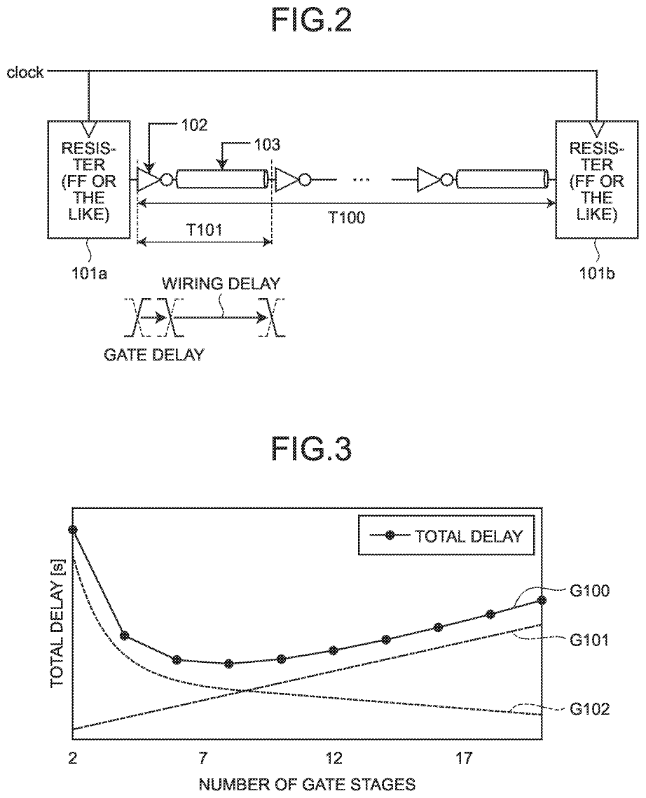

FIG. 2 is an explanatory diagram explaining an example of a long-distance wiring path. As illustrated in FIG. 2, the long-distance wiring path signifies a path in which plural sets of a gate 102 (hereinafter, also referred to as repeater buffer) and a wiring 103 are connected (in a multiple stage manner) between registers 101a and 101b, to transmit a signal.

Time for passing through the repeater buffer (gate 102) is referred to as gate delay, and time for passing through the wiring 103 is referred to as wiring delay. A total delay T101 per stage is a sum of this gate delay and the wiring delay. Moreover, a total delay T100 in the long-distance wiring path between the registers 101a and 101b is a total sum of the total delays T101 per stage.

Because a guide for the floor planning and the logical design cannot be generated without being able to grasp for how much distance transmission is possible using a technology such as wire miniaturization, derivation of an optimal circuit configuration of a long-distance wiring path in the illustrated example is important.

Such a derivation of an optimal circuit configuration of a long-distance wiring path is extremely challenging. FIG. 3 is an explanatory diagram explaining a relationship between the number of gate stage and a delay. In FIG. 3, a horizontal axis represents the number of gates, and a vertical axis represents the delay amount. A graph G100 indicates the total delay T100 with a fixed wiring distance. The graph G101 indicates a gate delay included in the total delay T100. the graph G102 indicates a wiring delay included in the total delay T100.

As illustrated in FIG. 3, in a region in which the number of gate is small and the wiring delay is dominant (for example, a second stage to a seventh stage), the total delay T100 decreases as the number of gate stage increases. This is explained by following two reasons.

Reason 1: Consider a case in which the number of gate stage is n (=wiring length per gate stage is 1/n times). The gate delay is constituted of a sum of “A: intrinsic gate delay” and “B: delay proportional to capacitance”. Because the capacitance is 1/n times when the wiring length per gate stage is 1/n times, B also becomes approximately 1/n times. As a result, A remains unchanged, but the gate delay per stage decreases due to the decrease in B.

Reason 2: A wiring delay is proportional to a square of a wiring length. When a wiring length per gate stage is 1/n times, the wiring delay becomes (1/n)² times, to be decreased. While the gate delay increases with the increase of the number of gate stage, the total delay T100 decreases because improvement to reduce the wiring delay exceeds it.

On the other hand, in a region in which the number of gate is large, and the gate delay is dominant (for example, an eighth stage and later), the total delay T100 increases as the number of gate increases. As described above, as the wiring length per gate decreases, the gate delay (B) and the wiring delay are reduced, but the total sum of A increases in proportion to the number of gate stage because the gate delay (A) remains unchanged. As the total sum of A exceeds a degree of improvement, the total delay T100 transitions to an increase.

Therefore, the derivation of an optimal circuit configuration with respect to a long-distance wiring path is merely a search for the number of gate stages that minimizes the total delay. However, the optimal number of gate stages varies depending on a cell type of repeater buffer (various vth, various driving strengths), a wiring layer, wiring width and spacing (hereinafter, denoted as wiring L/S), a wiring length, and a wiring corner. The affecting parameters are diverse, and it makes it difficult to estimate the number of gate stages for a long-distance wiring path.

Therefore, conventionally, a design method in which an optimal circuit configuration is estimated by inputting a wiring layer, L/S, a wiring length, and a wiring corner that are expected by the designer before cell arrangement has been provided.

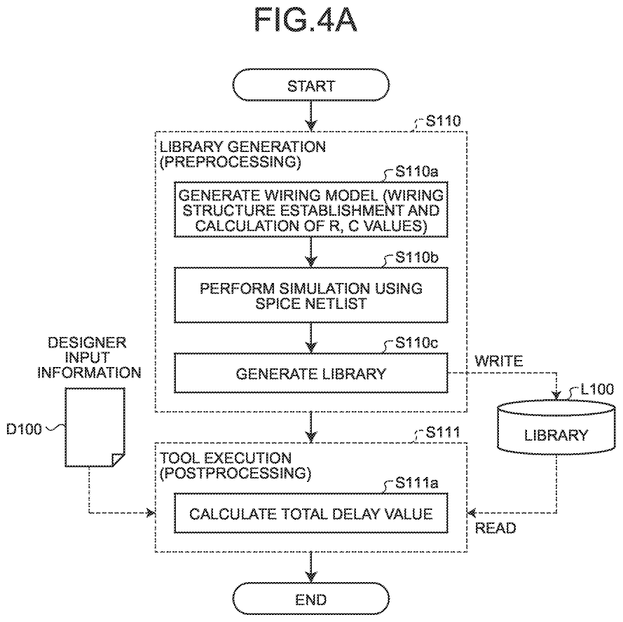

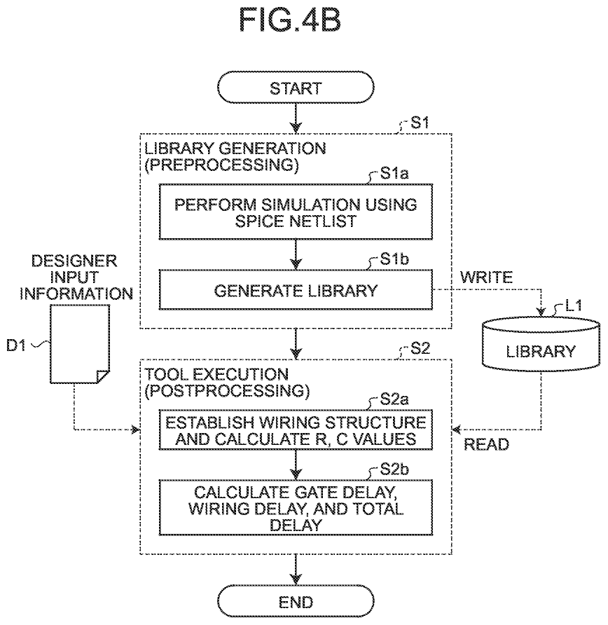

FIG. 4A is an explanatory diagram explaining an overview of an entire flow in a conventional technique. As illustrated in FIG. 4A, conventionally, a library is generated (preprocessing) in a design supporting apparatus that performs various kinds of processing relating to circuit design, and information relating to a wiring model is written in a library L100 in advance (S110).

Specifically, a wiring model is generated through a construction of a wiring structure and with values of R (resistance) and C (capacitance) (S110a). Subsequently, a simulation using a SPICE netlist is performed for the generated wiring model (S110b). Subsequently, library generation is performed based on results of the simulation (S110c), and it is written in the library L100.

Subsequently to the preprocessing described above, the conventional design supporting apparatus reads the library L100 generated in the preprocessing, and performs tool execution (postprocessing) based on input information D100 input by the designer (S111). Specifically, a total delay value of the wiring structure with respect to the input information D100 is calculated based on the library L100 (S111a).

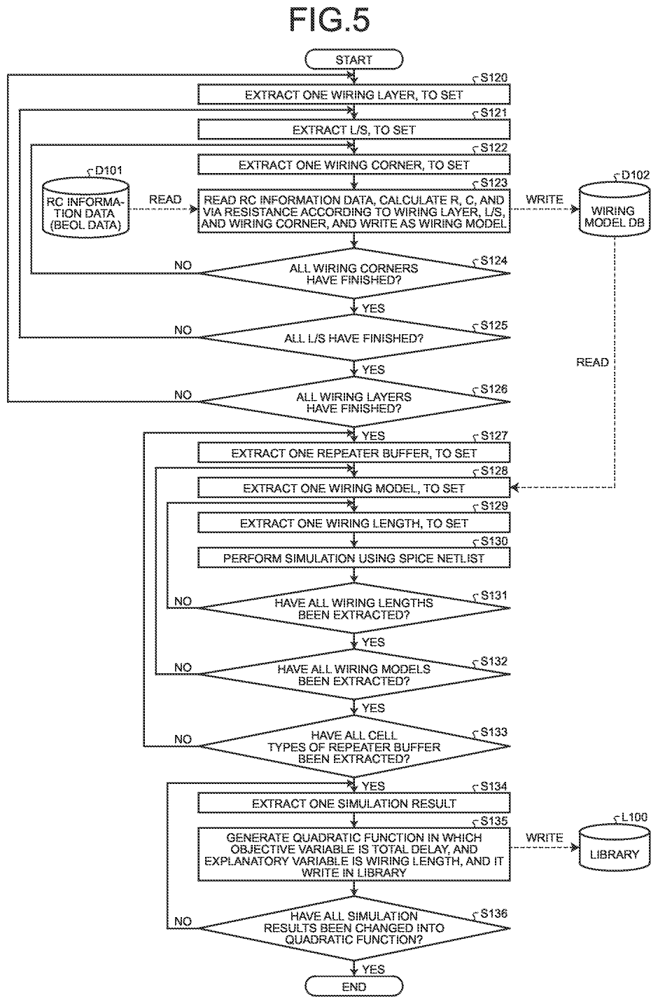

FIG. 5 is a flowchart illustrating a conventional library generation flow. As illustrated in FIG. 5, when library generation (preprocessing) is started, the conventional design supporting apparatus extracts one each of a wiring layer, L/S, and a wiring corner, and sets them (S120, S121, S122).

Subsequently, the conventional design supporting apparatus calculates R, C, and via resistance according to the wiring layer, L/S, and wiring corner, from RC information data D101 (BEOL data and the like) provided by a semiconductor vender, and writes in a wiring model DB D102 as a wiring model of the set wiring layer, L/S, and wiring corner (S123).

Subsequently, the conventional design supporting apparatus determines whether the setting of all of wiring corner have been finished (S124), and when it has not been finished (S124: NO), returns the processing to S122. When the setting of all of the wiring corners have been finished (S124: YES), the conventional design supporting apparatus determines whether the setting of all of L/S have finished (S125), and when it has not been finished (S125: NO), returns the processing to S121. When the setting of all of L/S has been finished (S125: YES), the conventional design setting apparatus determines whether the setting of all of wiring layers has been finished (S126), and when it has not been finished (S126: NO), returns the processing to S120. When the setting of the wiring layers has been finished (S126: YES), the conventional design supporting apparatus proceeds the processing to S127, exiting the loop of S120 to S126. Thus, R, C, and via resistance calculated for each wiring model are stored in the wiring model DB D102, associated with the respective wiring models.

Subsequently, the conventional design supporting apparatus performs simulation using an SPICE netlist for combinations of all wiring models, all cell types of repeater buffer, and all wiring lengths included in the wiring model DB D102 (S127 to S133). As for the wiring length, some points are selected within a range feasible in an actual design.

Specifically, the conventional design supporting apparatus extracts one each of repeater buffer, wiring model, and wiring length for all of the wiring models included in the wiring model DB D102, and set them (S127, S128, S129). Subsequently, the conventional design supporting apparatus performs simulation using an SPICE netlist for the set combinations (repeater buffer, wiring model, wiring length) (S130).

Subsequently, the conventional design supporting apparatus determines whether all of the wiring lengths have been extracted (S131), and when all of them have not been extracted (S131: NO), returns the processing to S129. When all of the wiring lengths have been extracted (S131: YES), the conventional design supporting apparatus determines whether all of the wiring models have been extracted (S132), and when not all have been extracted (S132: NO), returns the processing to S128. When all of the wiring models have been extracted (S132: YES), the conventional design supporting apparatus determines whether all of cell types of repeater buffer have been extracted (S133), and when not all have been extracted (S133: NO), returns the processing to S127. When all of the cell types of repeater buffer have been extracted (S133: YES), the conventional design supporting apparatus proceeds the processing to S134, exiting the loop of S127 to S133.

Subsequently, the conventional design supporting apparatus extracts one simulation result from among all of simulation results (S134). Subsequently, the conventional design supporting apparatus generates a quadratic function in which an objective variable is a total delay, and an explanatory variable is a wiring length, and writes it in the library L100 (S135). Subsequently, the conventional design supporting apparatus determines whether all simulation results have been changed into quadratic functions (S136), and when not have been changed into quadratic functions (S136: NO), returns the processing to S134. When all of them are changed into quadratic functions (S136: YES), the conventional design supporting apparatus ends the library generation processing.

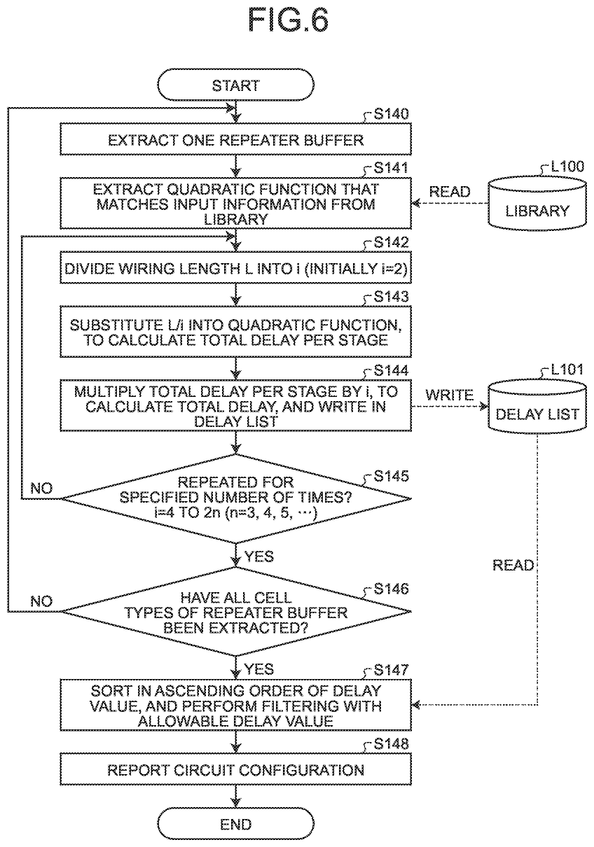

FIG. 6 is a flowchart illustrating a conventional tool execution flow. Prior to tool execution, a designer inputs the input information D100, such as wiring width, L/S, wiring length, wiring corner, and allowable delay amount, from an assumed floorplan, an assumed cell arrangement, and the like into the tool.

Subsequently, the conventional design supporting apparatus obtains a total delay per gate stage driving the wiring length. As an example, a case in which transmission is performed when the wiring length is L [m] and the number of gate stage is i is considered. First, the wiring length driven by each repeater buffer stage is L/i. Next, the conventional design supporting apparatus extracts a quadratic function in which the tool matches a combination of the wiring layer, L/S, wiring corner, and repeater buffer from the library. Subsequently, the conventional design supporting apparatus substitutes L/i in the extracted quadratic function, to calculate the total delay per stage. Finally, the conventional design supporting apparatus multiplies the total delay per stage by i, to obtain the total delay T100 when transmitted for L [m], and writes it in the delay list L101 together with the used repeat buffer and the number of gate stages. The conventional design supporting apparatus repeatedly performs the above operation for the arbitrary number of gate stages 2n (n=2, 3, . . . ), and obtains the total delay T100.

Specifically, as illustrated in FIG. 6, when the tool execution (postprocessing) is started, the conventional design supporting apparatus extracts one of repeater buffers from the input information D100 (S140).

Subsequently, the conventional design supporting apparatus extracts a quadratic function that matches the input information D100 from the library L100 (S141). Subsequently, the conventional design supporting apparatus divides the wiring length (L) into i (initially, i=2) (S142).

Subsequently, the conventional design supporting apparatus substitutes L/i into the quadratic function, to calculate the total delay T101 per stage (S143). Subsequently, the conventional design supporting apparatus multiplies the total delay T101 per stage by i, to calculate the total delay T100, and writes the calculated total delay T100 in the delay list L101 (S144).

Subsequently, the conventional design supporting apparatus determines whether it has been repeated for the specified number of times (i=4 to 2n, (n=3, 4, 5, . . . )) (S145), and when it has not been repeated (S145: NO), returns the processing to S142.

When it has been repeated for the specified number of times (S145: YES), the conventional design supporting apparatus determines whether all cell types of repeater buffer have been extracted (S146), and when not extracted yet (S146: NO), returns the processing to S140. When extracted (S146: YES), the conventional design supporting apparatus reads the delay list L101 and sorts delay values in ascending order, and performs filtering using an allowable delay value included in the input information D100 as a threshold (S147).

Subsequently, the conventional design supporting apparatus outputs an optimal circuit configuration to drive the wiring length acquired by performing the filtering as a report (S148), and ends the processing.

Based on this report, the designer checks results of the total delay, and if a solution is found, the estimation is to be finished. If no solution is found, the designer changes the wiring width, L/S, wiring length, and the like in the input information D100, and repeats this processing until a combination that fits within a predetermined delay time is found.

The number of simulations at the time of the library generation in the conventional design supporting apparatus is represented by following Equation 1.

Number of simulations=number of wiring layers×number of L/S×number of wiring corners×number of wiring lengths×number of repeater buffer cells (1)

Normally, as technology advances, the number of wiring layers in LSI increases. Because Equation 1 has the number of wiring layer as a variable, it is foreseen that the number of simulations increases as technology advances, to be impossible to accommodate.

Problem of being Unable to Accommodate Request for Changing Number of Vias

In recent years, with the advancement of technology miniaturization, there has been a tendency that a resistance of wiring portion increases. Particularly, a resistance value of a via connecting wiring layers with each other cannot be ignored. Therefore, the concept of redundant via of arranging plural vias to reduce a resistance value exists.

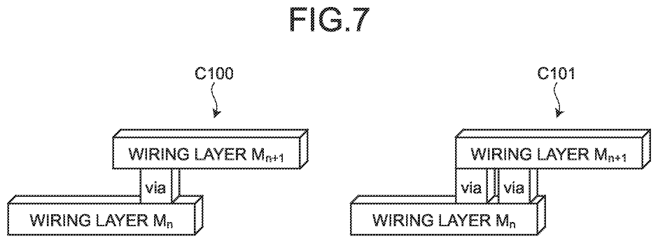

FIG. 7 is an explanatory diagram explaining an example of a regular via and a redundant via. As illustrated in FIG. 7, a case C100 is a case in which a wiring layer (Mₙ₊₁) and a wiring layer (Mₙ) are connected through a single via. A case C101 is a case in which the wiring layer (Mₙ₊₁) and the wiring layer (Mₙ) are connected through two vias. As this case C101, the redundant via in which plural vias are arranged to reduce a resistance value is a useful technique for a long-distance wiring path.

However, when a redundant via is installed, it is important to consider such a combination that vias between some wiring layers are the redundant via, while vias between other wiring layers are the regular via. In addition, consideration of a combination of the number of vias to be used is also necessary. In the conventional technique in which a wiring model is generated precisely before circuit simulations, a wiring model that completely covers all of the above combinations is necessary, and it is not practical.

Problem of being Unable to Change Crosstalk Delay Effect

Long-distance wiring paths is affected by a delay effect by crosstalk. This is an effect that affects a wiring delay, when one wiring (for example, wiring A) transitions, as an effective capacitance of the wiring A changes according to a condition of a capacitively coupled adjacent wiring (For example, wiring B). For this effect, simplified estimation of an effective capacitance of the wiring A is possible from a capacitance of the adjacent wiring by using the miller coupling factor (MCF).

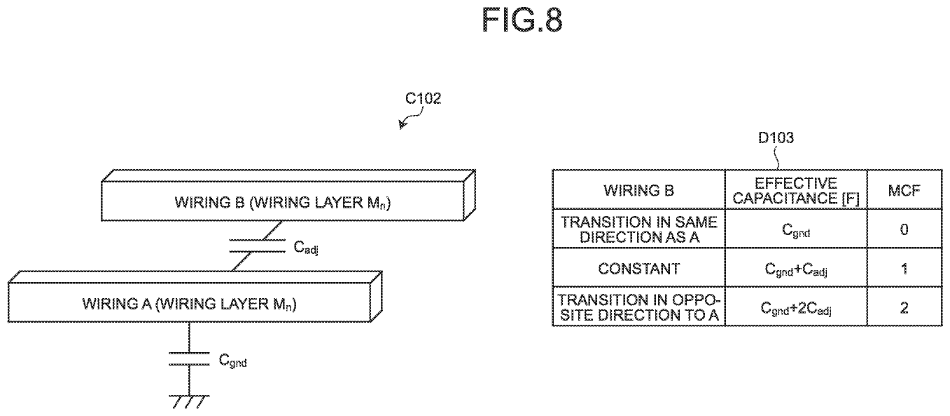

FIG. 8 is an explanatory diagram explaining estimation of a wiring delay using the MCF. As illustrated in a case C102 in FIG. 8, the wirings A and B are arranged adjacent to each other. Moreover, C_{gnd} represents an earth capacity of the wiring A, and C_{adj} represents a coupling capacitance of the wiring A and the wiring B.

In the case C102, for example, when potentials of the wiring A and the wiring B simultaneously transition, the effective capacitance of the wiring A is to be only the earth capacitance (C_{gnd}), and the coupling capacitance (C_{adj}) of the wiring B becomes invisible. Moreover, if the wiring B does not operate when the wiring A transitions, the effective capacitance of the wiring A can be expressed as a sum of C_{gnd} and C_{adj}.

That is, if the designer can guarantee that the wiring A and the wiring B simultaneously transition in the same direction on a logical side, MCF=0.0, if the designer can guarantee that the wiring A and the wiring B do not operate simultaneously, MCF=1.0, and if the designer can guarantee that the wiring A and the wiring B transition simultaneously in the opposite directions, MCF=2.0. As described, from a table D103 using the MCF, simplified estimation of an effective capacitance of the wiring A is possible from the adjacent wiring capacitance.

However, in the conventional technique in which a wiring model is generated precisely before circuit simulations (before tool execution), a wiring model that completely covers all combinations of the MCF is necessary, and it is not practical.

Problem of being Unable to Separate Gate Delay and Wiring Delay

In the conventional technique, a quadratic function is adopted for calculation of a total delay. This is based on an idea that the total delay increases proportional to a square of a wire length if the wiring delay is dominant. However, because that is not true for the gate delay, in a case in which the gate delay dominants, such as in a short-distance wiring, reduction of accuracy is caused, and there is a problem that the gate delay and the wiring delay cannot be separated.

As indicated in the entire flow in FIG. 4A, conventionally, a wiring model in which the number of vias and the MCF are uniquely determined is generated in a library generation phase, which is the preprocessing, simulations thereof are performed, and a library was generated. Therefore, conventionally, redundant via accommodation, changes in the crosstalk delay effect (MCF), and the like have been impossible in the tool execution phase, which is the postprocessing. If the redundant via accommodation or a change of the crosstalk delay effect (MCF) are to be accommodated, at the wiring model generation at the time of generating a library, which is the preprocessing, an enormous number of wiring models corresponding thereto and simulations are necessary, and it has not been practical.

### Overview of Embodiment

FIG. 4B is an explanatory diagram explaining an overview of an entire flow according to an embodiment. As illustrated in FIG. 4B, the design supporting apparatus according to an embodiment performs a simulation using a SPICE netlist for an abstracted wiring model (details will be described later) (S1a) in library generation (preprocessing) (S1). Subsequently, the design supporting apparatus according to the embodiment performs library generation based on results of this simulation, and writes it in a library L1 (S1b).

Subsequently, the design supporting apparatus according to the embodiment reads designer input information D1 of the designer and the library L1 acquired by the library generation in tool execution (postprocessing) (S2). Subsequently, the design supporting apparatus according to the embodiment performs wiring structure development and calculation of R, C values in this wiring structure (S2a), and performs calculation of a gate delay, a wiring delay, and a total delay (S2b).

In the following explanation, a wire resistance and a capacitance obtained by performing wiring structure development and by calculating from the wiring structure are denoted as R and C (uppercase), respectively, and a wire resistance and a capacitance that are used in a simulation at library generation are denoted as r and c (lowercase), respectively, to distinguish from each other.

As described, the design supporting apparatus according to the embodiment changes to a flow in which wiring structure development and calculation of R, C values in the wiring structure are performed at the time of tool execution, which is postprocessing. Thus, redundant via settings and MCF settings input by the designer can be incorporated, and can be reflected to R, C values.

Specifically, for a simulation in the library generation, which is preprocessing, an abstracted wiring model in which intrinsic information (wiring layer, L/S, wiring corner) is excluded and only r, c values are defined is used.

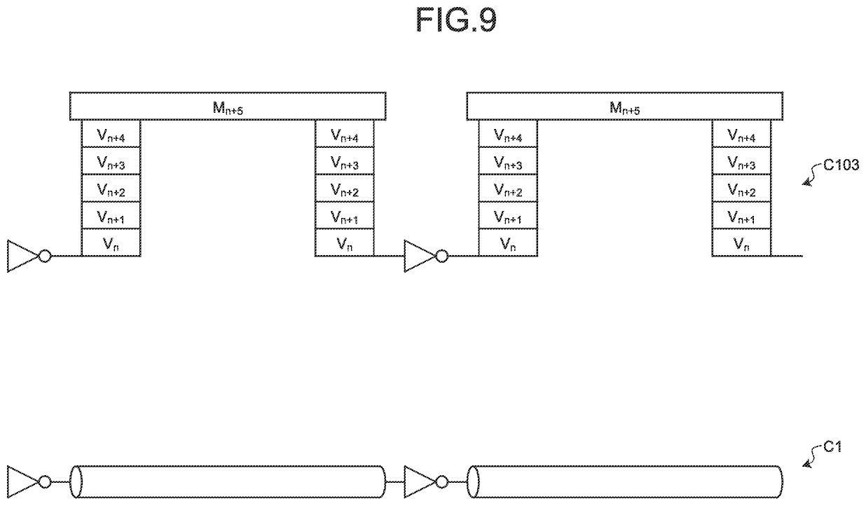

FIG. 9 is an explanatory diagram explaining an example of a conventional wiring model and a wiring model according to the embodiment. As illustrated in FIG. 9, a case C103 is a case of a conventional wiring model, and the wiring layer, L/S, wiring corner, and R, C values are incorporated in the wiring model. A case C1 is a case of the wiring model according to the embodiment, and only r, c values are defined, without information about wiring layer, L/S, wiring corner, and the like.

The design supporting apparatus according to the embodiment evaluate a gate delay and a wiring delay when one wiring model only having information of r, c values is connected to a repeater buffer by simulations.

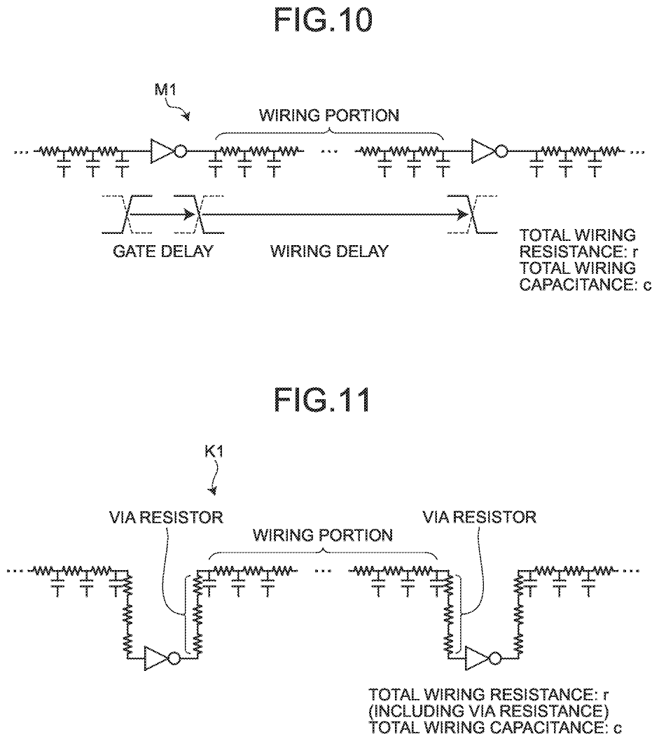

FIG. 10 is an explanatory diagram explaining an example of a wiring model. As illustrated in FIG. 10, in a wiring model M1, a π-type ladder is used, not a lumped capacitance, to improve the precision.

The design supporting apparatus according to the embodiment generates a library by associating specific r, c values with a gate delay and a wiring delay at that time after performing the simulations. That is, following Equation 2 is established among the r, c values and the gate delay and wiring delay.

$$Delay [ s ] = f ( r , c ) \qquad ( 2 )$$

As for specific r, c values, several or several tens of points may be selected within a feasible range in an actual design, and by setting it to a wide range in advance, it is possible to eliminate technology dependence.

In the design supporting apparatus according to the embodiment, by developing a wiring structure according to the designer input information D1 input by the designer, and calculating R, C values, to substitute into Equation 2 at the time of tool execution of the postprocessing, a gate delay and a wiring delay of various wiring structures can be calculated. That is, redundant via accommodation or change of MCF are possible.

However, sufficient precision cannot be acquired only with Equation 2. This is originated in that structures of a via resistor portion are different between a wiring structure assumed in an actual layout and a wiring model exemplified in FIG. 10.

FIG. 11 is an explanatory diagram explaining an example of a wiring structure. As illustrated in FIG. 11, in a wiring structure K1 assumed in an actual layout, a via resistor corresponding to a via is included. Therefore, in the wiring structure K1, this via resistor portion is different from that of the wiring model exemplified in FIG. 10.

Therefore, even if a combined resistance and a combined capacitance are consistent between FIG. 10 and FIG. 11, delay values do not coincide with each other under specific condition. This is explained by a relationship between a driver resistance of a repeater buffer itself and a connected wiring resistance.

If wiring resistance<<driver resistance, because a total capacitance value connected downstream is visible from a repeater buffer, Equation 2 can hold. However, if wiring resistance>>driver resistance, a total capacitance value connected downstream is invisible from the repeater buffer due to resistive shielding. As a result, Equation 2 does not hold. That is, depending on a via resistance value connected right after the repeater buffer, an effective capacitance visible therefrom varies.

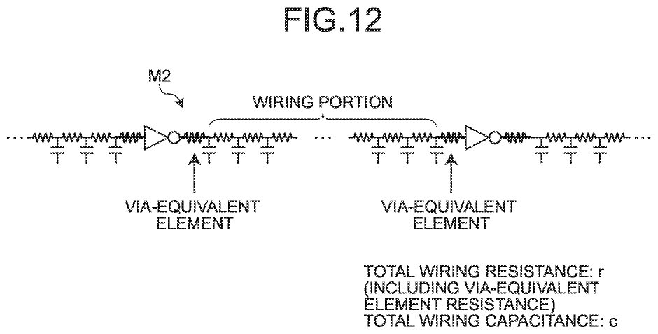

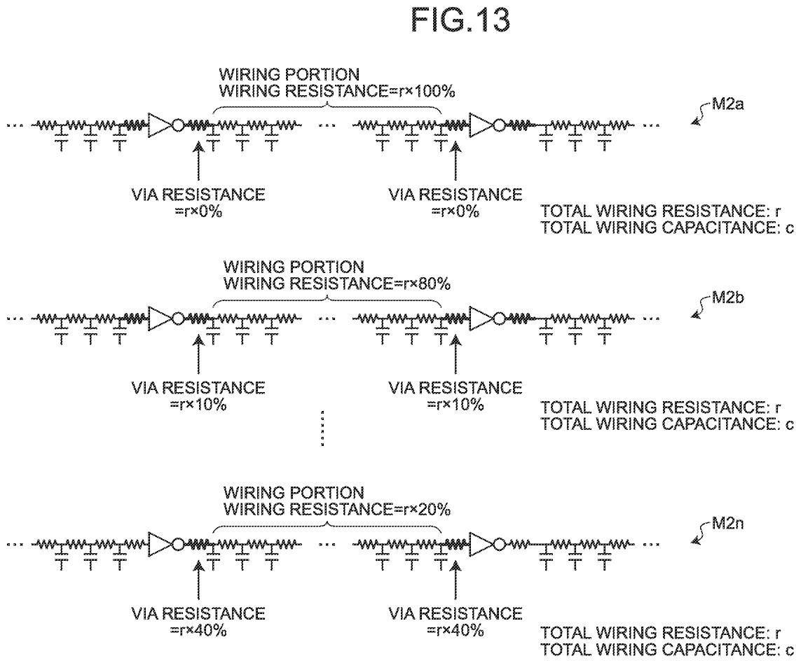

Accordingly, via-equivalent elements are incorporated at a starting point and an ending point of a wiring in the wiring model M1 proposed in FIG. 10, to expand the wiring model. FIG. 12 and FIG. 13 are explanatory diagrams explaining an example of expansion of a wiring model.

As illustrated in FIG. 12, in an expanded wiring model M2, via-equivalent elements are incorporated at a starting point and an ending point with respect to the wiring model M1. A resistance value of the via-equivalent element is defined by a ratio to the entire wiring resistance (r). Specifically, as illustrated in FIG. 13, wiring models M2a, M2b, . . . , M2n of respective ratios of via resistance to the total wiring resistance (r) (for example, 0%, 20%, . . . , 80%) are constructed. The design supporting apparatus according to the embodiment calculates a gate delay and a wiring delay of each of these wiring models M2a, M2b, . . . , M2n.

This idea is called via ratio model, and is defined by following Equation 3.

via ratio=via resistance/r (0≤via ratio≤1.0) (3)

The design supporting apparatus according to the embodiment establishes Equation 2 all the time by introducing the via ratio model into the wiring models M2a, M2b, . . . , M2n and the library L1. The wiring models M2a, M2b, . . . , M2n and the library L1 in which this via ratio model is incorporated and the library L1 may be called via-ratio-compatible expanded wiring model, via-ratio-compatible expansion library, respectively.

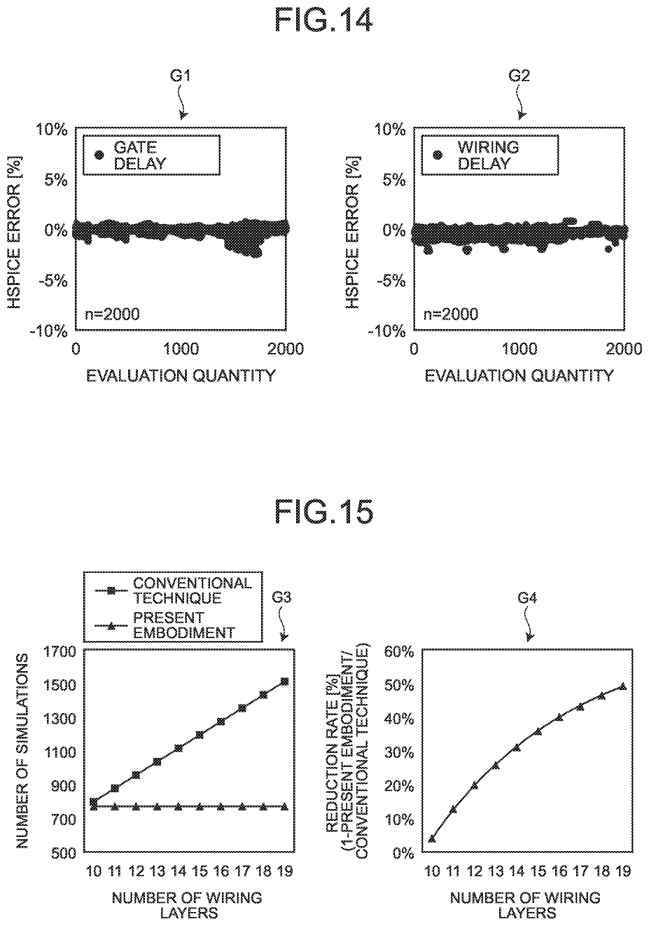

FIG. 14 and FIG. 15 are explanatory diagrams explaining an example of a result of simulation. As for the simulation, in the conventional technique, the number of L/S is 4 points, the number of wiring corner is 2 points, and the number of wiring length is 10 points. Moreover, in the present embodiment, the number of r point is 10 points, the number of c point is 7 points, and the number of via-ratio model generation point is 11 points.

Graphs G1 and G2 in FIG. 14 are graphs in which results of the simulation of the present embodiment are plotted with a horizontal axis for an evaluation quantity, and a vertical axis for HSPICE error [%]. The graph G1 indicates an evaluation result of a gate delay, and the graph G2 indicates an evaluation result of a wiring delay.

As illustrated in FIG. 14, in the simulation result of the present embodiment, the precision of HSPICE ratio±5% (equivalent or superior to the conventional) is maintained.

A graph G3 in FIG. 15 is a graph in which the simulation results of the conventional technique and the present embodiment are plotted with a horizontal axis for the total number of wirings, and a vertical axis for the number of simulations. A graph G4 in FIG. 15 is a graph in which the simulation results are plotted with a horizontal axis for the total number of wirings, and a vertical axis for a reduction rate in the number of simulations (1-present embodiment/conventional technique).

As illustrated in FIG. 15, in the present embodiment, the number of simulations is reduced by approximately 40% compared with the conventional technique (compared between wiring layers of 16). Moreover, in the present embodiment, as the number of wiring layers, the number of L/S, and the number of corners increase with advanced technology, the reduction rate of the number of simulations with respect to the conventional technique increases. As described, in the design supporting apparatus according to the present embodiment, the redundant via accommodation and a change of the MCF are enabled without increasing the number of simulations. As a result, the design supporting apparatus of the present embodiment can provide, before floor planning or a cell arrangement phase (at the time of logical design), delay information of various wiring structures for a long-distance wiring path for which estimation of the number of gate stages is difficult.

### About Embodiment

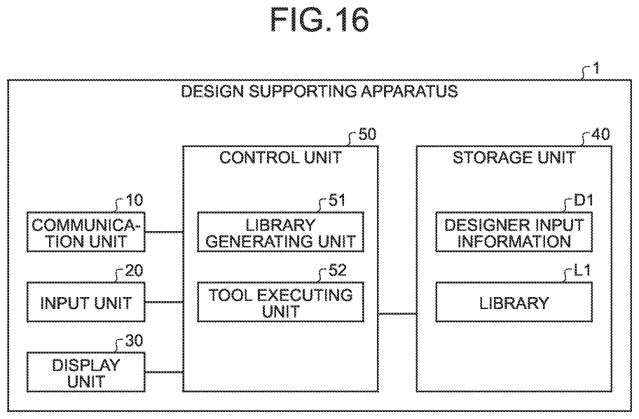

FIG. 16 is a block diagram illustrating a functional configuration example of the design supporting apparatus according to the embodiment. As illustrated in FIG. 16, a design supporting apparatus 1 includes a communication unit 10, an input unit 20, a display unit 30, a storage unit 40, and a control unit 50.

The communication unit 10 receives various kinds of data from an external device through a network. The communication unit 10 is one example of a communication device. For example, the communication unit 10 may receive various kinds of setting information (for example, designer input information D1) relating to circuit design and the like from an external device.

The input unit 20 is an input device that inputs various kinds of information to the control unit 50 of the design supporting apparatus 1. The input unit 20 corresponds to a keyboard, a mouse, a touch panel, and the like. For example, the input unit 20 accepts the designer input information D1 and the like by an input operation performed by a user.

The display unit 30 is a display device that displays information output from the control unit 50. For example, the display unit 30 displays a report, such as simulation results, under control of the control unit 50.

The storage unit 40 stores data, such as the designer input information D1 and the library L1. The storage unit 40 corresponds to a storage device including a semiconductor memory device, such as a random access memory (RAM) and a flash memory, a hard disk drive (HDD), and the like.

The control unit 50 includes a library generating unit 51 and a tool executing unit 52. The control unit 50 is implemented by, for example, a central processing unit (CPU), a graphics processing unit (GPU), an application specific integrated circuit (ASIC), a hardwired logic, such as a field programmable gate array (FPGA), or the like.

The library generating unit 51 is a processing unit that performs processing relating to library generation (preprocessing) (S1). The tool executing unit 52 is a processing unit that performs processing relating to tool execution (postprocessing) (S2).

First, the processing of library generation (preprocessing) performed by the library generating unit 51 will be explained. The library generating unit 51 performs the library generation (preprocessing) before a floorplan estimation or a cell arrangement phase in an LSI design flow. The library generating unit 51 simulates a gate delay and a wiring delay using a SPICE netlist under various PVT conditions (transistor process condition, voltage condition, temperature condition) when a via-ratio-compatible expanded wiring model in which certain r and c values where via ratio=0.0 are set to a repeater buffer is connected. For the certain r and c, several to several tens of points may be selected within a range feasible in an actual design, and by setting it to a wide range in advance, it is possible to eliminate technology dependence.

Subsequently, the library generating unit 51 generates a via ratio model of other than via ratio=0.0. As the via ratio model generation points, several points are selected within a range of 0 to 1.0. Intervals between points are not limited. The library generating unit 51 performs the above processing with respect to all of the via ratio model generation points.

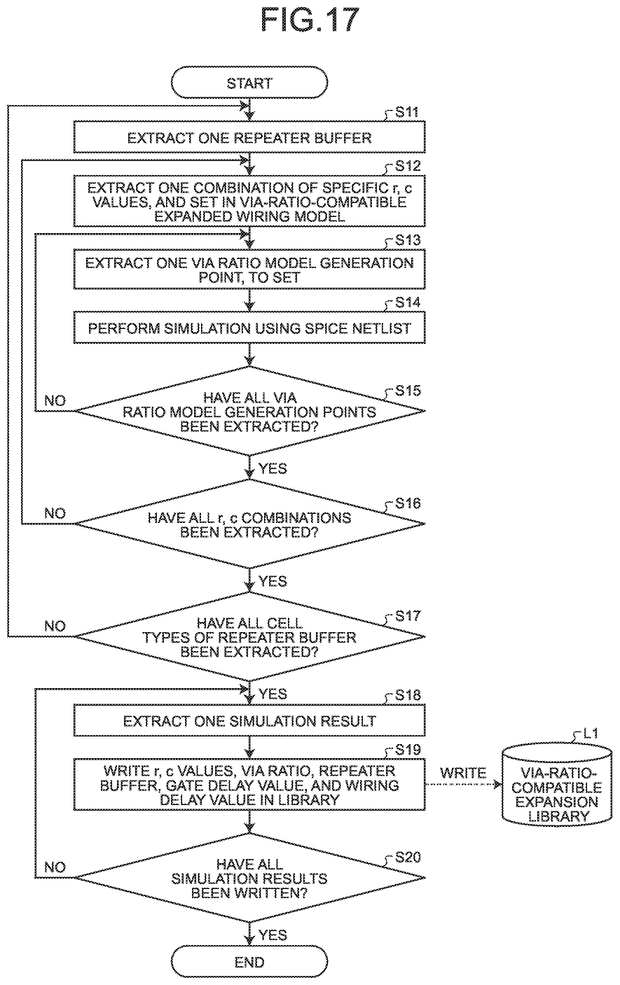

FIG. 17 is a flowchart illustrating a library generation flow of the design supporting apparatus 1 according to the embodiment.

As illustrated in FIG. 17, when processing is started, the library generating unit 51 extracts one repeater buffer arbitrarily and makes settings (S11). Subsequently, the library generating unit 51 extracts one combination of certain r and c values, to set to a via-ratio-compatible expanded wiring model (S12). Subsequently, the library generating unit 51 extracts a generation point of the via ratio model, and sets a via resistance with which the via ratio is within a range of 0.0 (0%) to 1.0 (100%) (S13).

Subsequently, the library generating unit 51 performs simulations using a SPICE netlist under various PVT conditions with values set at S11 to S13 (S14).

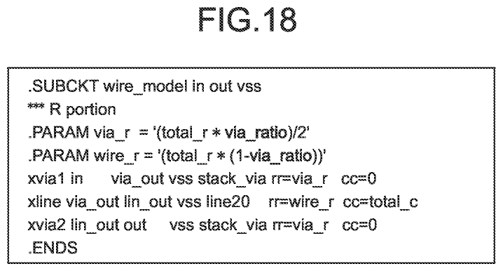

FIG. 18 is an explanatory diagram illustrating a description example of an SPICE deck. As illustrated in FIG. 18, the library generating unit 51 performs simulations under a condition set to the SPICE deck.

By this simulation, the library generating unit 51 obtains a gate delay and a wiring delay. Subsequently, the library generating unit 51 determines whether all of the via ratio model generation points have been extracted (S15), and when all of them have not been extracted (S15: NO), returns the processing to S13.

When all have been extracted (S15: YES), the library generating unit 51 determines whether all of r, c combinations have been extracted (S16), and when all of r, c combinations have not been extracted (S16: NO), returns the processing to S12.

When all of r, c combinations have been extracted (S16: YES), the library generating unit 51 determines whether all cell types of repeater buffers have been extracted (S17), and all of them have not been extracted (S17: NO), returns the processing to S11.

When all cell types of repeater buffers have been extracted (S17: YES), the library generating unit 51 proceeds the processing to S18 exiting the loop of S11 to S17. By this loop, the library generating unit 51 performs simulations with respect to all cell types of repeater buffers that can be used in an actual design, to obtain a gate delay and a wiring delay of the via-ratio-compatible expanded wiring model.

The number of simulations at this time is expressed as following Equation 4. Compared to Equation 1, because there is no technology dependent part, an increase in the number of simulations with advanced technology does not occur.

Number of simulations=number of r points×number of c points×number of via ratio model generation points×number of repeater buffers (4)

Subsequently, the library generating unit 51 extracts one of simulation results (S18), and writes the r and c values, the via ratio, the repeater buffer, the gate delay value, and the wiring delay value in the library L1 (via-ratio-compatible expansion library) (S19).

Subsequently, the library generating unit 51 determines whether all simulation results have been written in the library L (S20), and when all have not been written (S20: NO), returns the processing to S18. When all have been written (S20: YES), the library generating unit 51 ends the processing of library generation.

As described above, the library generating unit 51 creates a library with the simulation results in the library L1. Specifically, the library generating unit 51 does not use an approximate expression because the gate delay and the wiring delay are separated, but forms a lookup table (hereinafter, denoted as LUT) associating the r and c values used in the simulations, the via ratio, the repeater buffer, the gate delay, and the wiring delay with one another

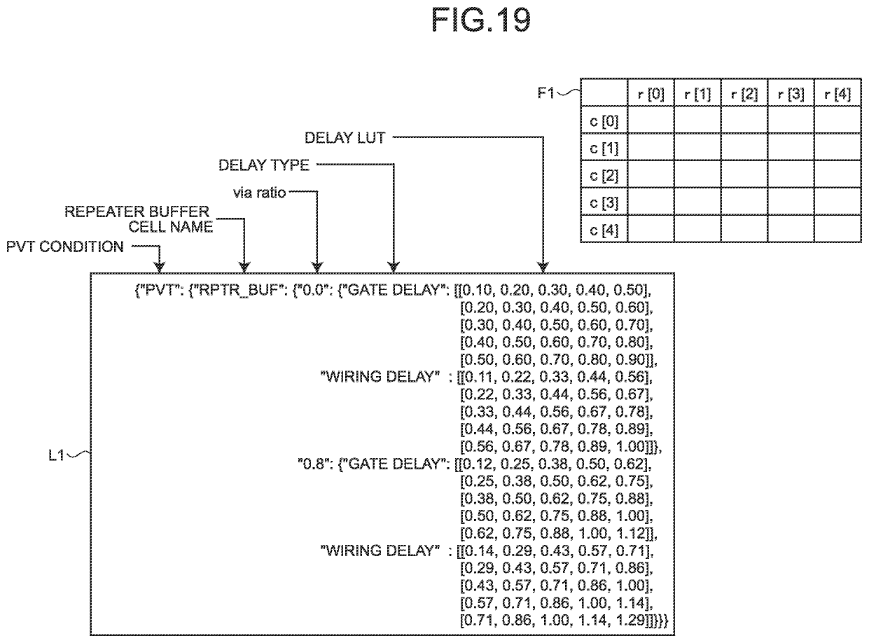

FIG. 19 is an explanatory diagram explaining an example of a via-ratio-compatible expansion library. As illustrated in FIG. 19, the library L1 (via-ratio-compatible expansion library) may be implemented by Javascript object notation (JSON). The implementation example exemplified in FIG. 18 is an LUT in a format F1 in which a horizontal axis (x-direction) is for r, and a vertical axis (y-direction) is for c. Moreover, although FIG. 18 illustrates an LUT associated when the via ratio is 0.0 as an example, a similar LUT is associated also with a via ratio other than 0.0 (for example, 0.1, 0.2, . . . ). Naturally, the library L1 is not limited to the illustrated example (JSON format), but any format may be used.

Furthermore, the number of points of r and c may be set as appropriate. While r and c are discrete values in increments of 5 points in the illustrated example, it is not necessarily limited to 5 points, and may be discrete values in increments of, for example, 10 points.

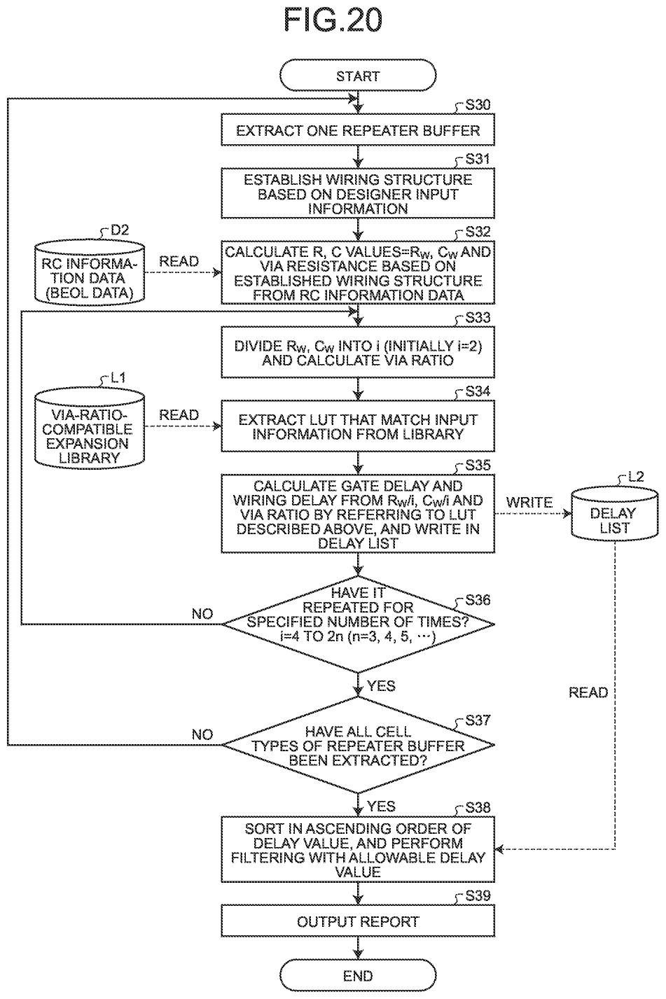

Next, processing of tool execution (postprocessing) performed by the tool executing unit 52 will be explained. FIG. 20 is a flowchart illustrating a tool execution flow of the design supporting apparatus 1 according to the embodiment. Prior to the tool execution, the designer inputs the designer input information D1 into the design supporting apparatus 1. The designer input information D1 includes a wiring layer, an L/S, a wiring length, a wiring corner, an allowable delay value, the number of redundant via (optional), an MCF (optional).

As illustrated in FIG. 20, when the processing is started, the tool executing unit 52 extracts one repeater buffer from the designer input information D1 (S30). Subsequently, the tool executing unit 52 establishes a wiring structure between resistors relating to the repeater buffer based on the designer input information D1 (S31).

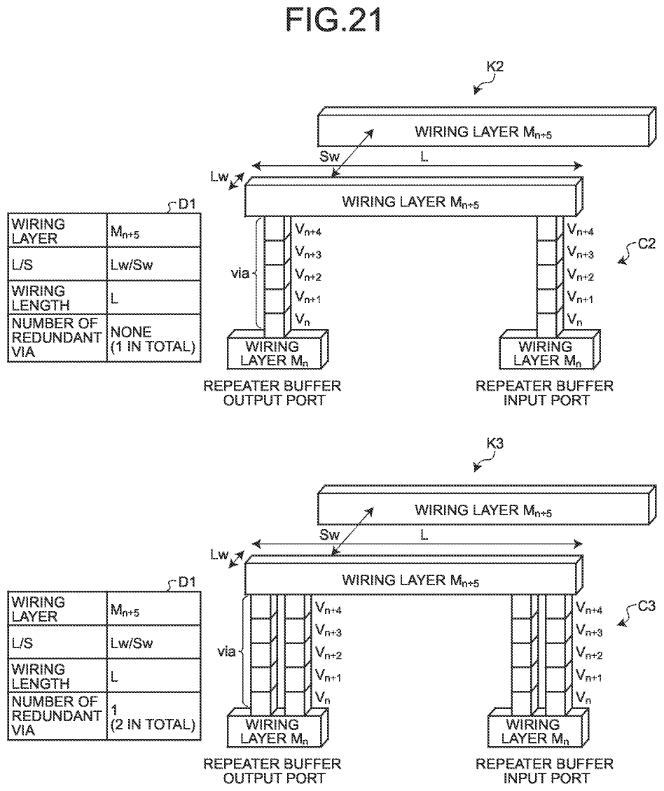

FIG. 21 is an explanatory diagram explaining an example of a wiring structure. As illustrated in FIG. 21, in a case C2, the tool executing unit 52 establishes a wiring structure K2 without redundant via, based on conditions described in the designer input information D1 (number of redundant via: non (1 in total)). As for the wiring structure K2, a wiring layer is represented by Mₙ₊₅, the L/S is represented by L_{w}/S_{w}, and the wiring length is represented by L.

Similarly, in the case C3, the tool executing unit 52 establishes a wiring structure K3 with a redundant via, based on conditions described in the designer input information D1 (number of redundant via: 1 (2 in total)). As for the wiring structure K3, the wiring layer is represented by Mₙ₊₅, the L/S is represented by L_{w}/S_{w}, and the wiring length is represented by L. Naturally, the number of redundant vias to be used may be any number as long as it is a natural number. Moreover, the tool executing unit 52 is also capable of processing of changing only Vₙ to a redundant via.

Subsequently, an actual layout does not exist at the time of this tool execution, the tool executing unit 52 calculates R, C value=R_{w}, C_{w}, and a via resistance based on a wiring structure established from RC information data D2 provided by a semiconductor vender (S32).

Subsequently, the tool executing unit 52 divides R, C values=R_{w}, C_{w} into i (initially i=2) according to the number of stages (i), and calculates the via ratio (S33).

As an example, suppose that the wiring length is L [m], the wiring layer used for transmission is Mₓ, R, C values of the wiring length L are Rw [ohm], C_{w} [F], respectively, and a via resistance from an output port of the repeater buffer to Mₓ is Rᵥ [ohm]. This condition is considered when transmission is performed when the number of gate stages is i. As the wiring length driven per one stage of repeater buffer is L/i, R, C values are R_{w}/i, C_{w}/i, respectively. The via resistance is to be 2Rᵥ because there are a route from the output port of the repeater buffer to Mₓ and a route from Mₓ to the input port of the repeater buffer. The via ratio at this time is to be vr=2Rv/(Rw/i+2Rv).

As for the C value, the tool executing unit 52 determines a value based on the MCF that is a factor indicating a transition state of two wirings adjacent to each other included in the wiring structure. Specifically, as illustrated in FIG. 8, the tool executing unit 52 determines a capacitance based on MCF=0.0 (adjacent wirings transition at the same time in the same direction), MCF=1.0 (not transition at the same time in the same direction), MCF=2.0 (transition at the same time in the opposite directions).

Subsequently, the tool executing unit 52 extracts an LUT that matches the designer input information D1 from the library L1 (S34). Subsequently, the tool executing unit 52 calculates a gate delay and a wiring delay from R_{w}/i, C_{w}/i, and the via ratio by referring to the LUT. The tool executing unit 52 calculates a delay value at L [m] by multiplying the calculated gate delay and wiring delay (delay value per stage) by i, write into the delay list L2 together with the used repeater buffer and the number of gate stages (S35).

The tool executing unit 52 determines whether the above operation has been repeated for the specified number of times (arbitrary number of gate stages i=4 to 2n (n=3, 4, 5, . . . )) (S36), and when not repeated yet (S36: NO), returns the processing to S33.

When it has been repeated for the specified number of times (S36: YES), the tool executing unit 52 determines whether all cell types of repeater buffer have been extracted (S37), and when not all have been extracted yet (S37: NO), returns the processing to S30.

When all cell types of repeater buffer have been extracted (S37: YES), the tool executing unit 52 reads the delay list L2 and sorts the delay values in ascending order, and performs filtering using the allowable delay value included in the designer input information D1 as a threshold (S38).

Subsequently, the tool executing unit 52 outputs an optimal circuit configuration to drive the wiring length acquired by performing the filtering as a report (S39), and ends the processing.

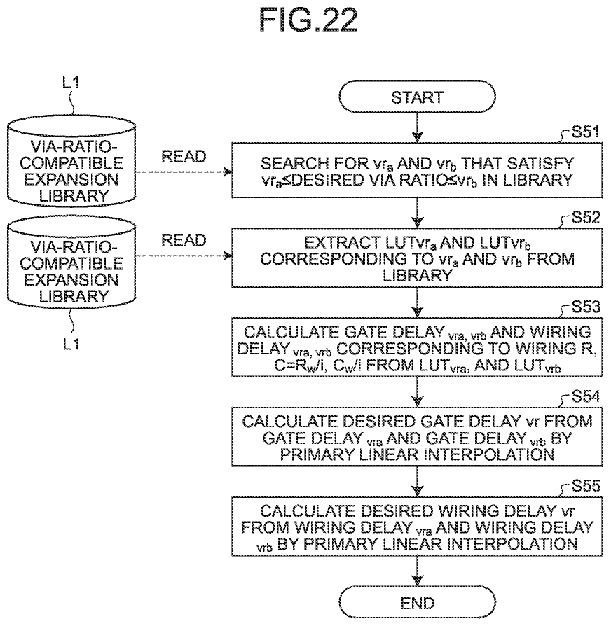

FIG. 22 is a flowchart illustrating an example of delay calculation of the design supporting apparatus 1 according to the embodiment. As illustrated in FIG. 22, the tool executing unit 52 searches for vrₐ and vr_{b} that satisfy vrₐ≤desired via ratio≤vr_{b} from the library L1 (S51).

Subsequently, the tool executing unit 52 extracts an LUT (LUTᵥᵣₐ, LUT_{vrb}) corresponding to vrₐ and vr_{b} (S52).

Subsequently, the tool executing unit 52 calculates a gate delay _{vra, vrb}, a wiring delay _{vra, vrb} per stage corresponding to the wiring R, C=R_{w}/i, C_{w}/i from the LUTᵥᵣₐ, LUT_{vrb} (S53).

These gate delay _{vra, vrb}, wiring delay _{vra, vrb} are obtained by interpolating discrete values included in the LUT.

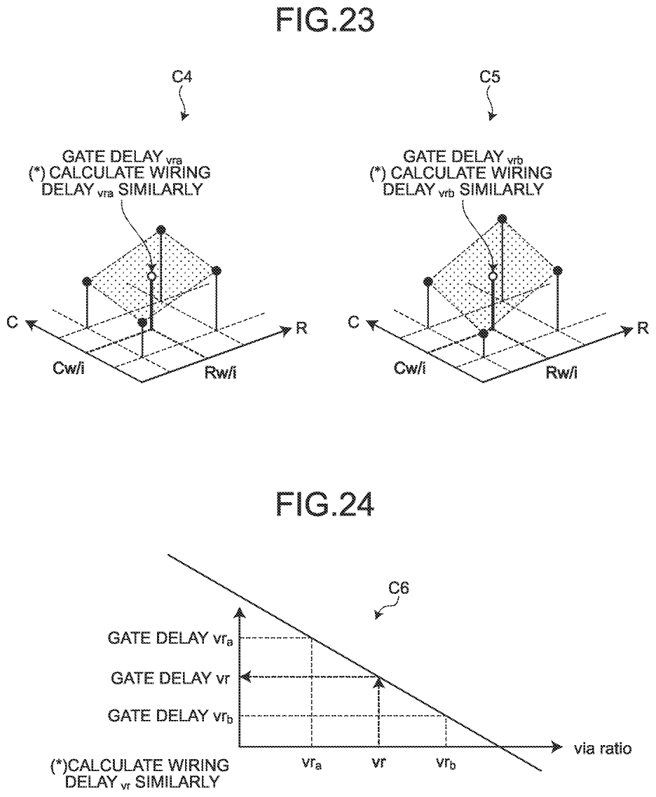

FIG. 23 is an explanatory diagram explaining an example of linear interpolation. A case C4 in FIG. 23 illustrates a case in which the gate delay ᵥᵣₐ is calculated by linear interpolation. A case C5 illustrates an example of calculating the gate delay _{vrb} by linear interpolation. As illustrated in FIG. 23, because values included in the LUT are discrete values, the tool executing unit 52 linearly interpolates the discrete values, to obtain a value corresponding to the gate delay _{vra, vrb}. The tool executing unit 52 similarly calculates the wiring delay _{vra, vrb} also.

Subsequently, the tool executing unit 52 calculates a desired gate delay ᵥᵣ obtained from the gate delay ᵥᵣₐ and the gate delay _{vrb} by primary linear interpolation (S54).

Subsequently, the tool executing unit 52 calculates a desired gate delay ᵥᵣ from the wiring delay ᵥᵣₐ and the wiring delay _{vrb} by primary linear interpolation (S55).

FIG. 24 is an explanatory diagram explaining an example of linear interpolation. As illustrated in a case C6 in FIG. 24, the gate delay and the via ratio have a relationship in which the gate delay decreases in proportion to the increase in the via ratio. Therefore, the tool executing unit 52 can obtain the desired gate delay ᵥᵣ from the gate delay ᵥᵣₐ and the gate delay _{vrb} by primary linear interpolation. Similarly, the wiring delay ᵥᵣ can be obtained by primary linear interpolation. Although linear interpolation is used in the present embodiment, other interpolation methods may, of course, be selected.

The designer checks the total delay by the report at S39, and if there is a solution, the estimation is to be finished. If the result of filtering leads to no solution, the designer changes contents of the designer input information D1, and performs evaluation again.

Conventionally, under the assumption of transmission for L [m], it has been only possible to change the wiring layer or L/S. Therefore, conventionally, if the allowable delay value is not achieved with changes in those, there is no other way but to shorten the premise L, and changes of the floorplan is unavoidable.

On the other hand, in the design supporting apparatus 1 according to the embodiment, in addition to modification of the wiring layer and L/S, the redundant via accommodation and changes in the MCF are possible. Therefore, even in a case in which an allowable value has been unable to be achieved also, various wiring structures can be evaluated before arranging cells. It is possible to choose a design method other than shortening the wiring length, and to give high flexibility to floorplan formulation. It is possible to provide highly flexible design method to designers.

As described above, the design supporting apparatus 1 generates a wiring model between the registers 101a and 101b in which the gate 102 and the wiring 103 included between the registers 101a and 101b are replaced with a resistor and a capacitance, and a via arranged across wiring layers between the registers 101a and 101b is replaced with a via resistor. The design supporting apparatus 1 calculates a gate delay and a wiring delay for each ratio of the via resistor to the total resistors of the wiring structure between the registers 101a and 101b in this wiring model. The design supporting apparatus 1 writes the calculated gate delay and wiring delay for each ratio in the wiring model in the library information (library L1) relating to the circuit design.

By generating such library information before tool execution, the design supporting apparatus 1 can suppress an increase in the number of simulations for design changes of a circuit to accommodate a redundant via.

Moreover, the design supporting apparatus 1 accepts the designer input information D1 relating to a wiring structure to be designed, and calculates, based on the library information (designer input information D1), a delay in the wiring structure established based on the accepted designer input information D1. Thus, the design supporting apparatus 1 can obtain a delay in a wiring structure that accommodate a redundant via.

Furthermore, the designer input information D1 includes an element indicating a transition state of two wirings that are adjacent to each other included in a wiring structure to be designed. The design supporting apparatus 1 determines a capacitance of the two wirings based on this element. Thus, the design supporting apparatus 1 can reproduce a delay caused according to the transition state of the two wirings adjacent to each other, that is, a cross-talk delay effect.

Moreover, the design supporting apparatus 1 writes discrete values of a gate delay and a previous wiring delay in the library information (library L1). The design supporting apparatus 1 calculates a delay by linear interpolation based on the discrete value of the gate delay and the wiring delay included in this library information. Thus, the design supporting apparatus 1 can obtain a delay amount from the discrete values included in the library information. Therefore, in the design supporting apparatus 1, it is not necessary to prepare all values anticipated in a design in the library information.

The respective components of the respective illustrated devices are not necessarily required to be configured physically as illustrated. That is, specific forms of distribution and integration of the respective devices are not limited to the ones illustrated, and all or some thereof can be configured to be distributed or integrated functionally or physically in arbitrary units according to various kinds of loads, usage conditions, and the like.

Moreover, the various kinds of processing functions of the library generating unit 51 and the tool executing unit 52 performed by the control unit 50 of the design supporting apparatus 1 may be configured such that all or an arbitrary part thereof is performed on a microcomputer, such as CPU (or microcomputer, such as MPU and micro controller unit (MCU)). Moreover, it is needless to say that all or an arbitrary part of the respective processing functions may be performed on a program analyzed and executed on a CPU (or microcomputer, such as MPU and MCU), or on hardware by wired logic. Furthermore, the respective processing functions performed by the design supporting apparatus 1 may be performed in cooperation among multiple computers using cloud computing.

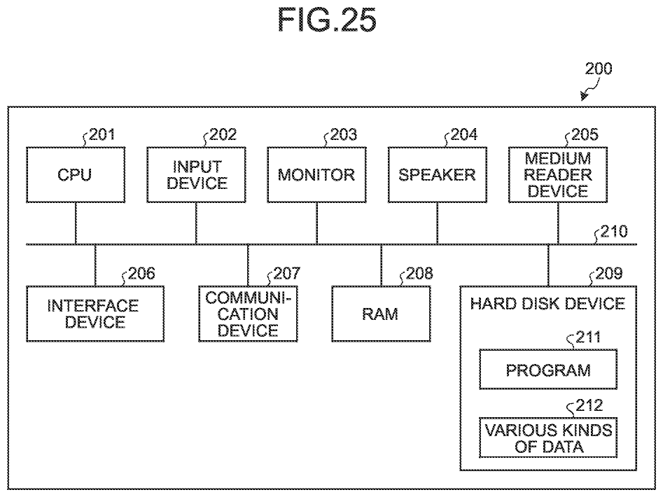

The respective processing explained in the above embodiment can be implemented by executing a computer program prepared in advance by a computer. Accordingly, an example of a computer configuration (hardware) that executes a program having functions similar to those of the above embodiment will be explained in the following. FIG. 25 is an explanatory diagram explaining an example of the computer configuration.

As illustrated in FIG. 25, a computer 200 includes a CPU 201 that performs various kinds of arithmetic processing, an input device 202 that accepts data input, a monitor 203, and a speaker 204. Moreover, the computer 200 includes a medium reader device 205 that reads a program and the like from a storage medium, an interface device 206 to connect to various kinds of devices, and a communication device 207 to connect with external device for communication wiredly or wirelessly. Furthermore, the design supporting apparatus 1 includes a RAM 208 that temporarily stores various kinds of information, and a hard disk device 209. Moreover, respective components (201 to 209) in the computer 200 are connected to a bus 210.

In the hard disk device 209, a program 211 to execute various kinds of processing in the functional components (for example, the library generating unit 51 and the tool executing unit 52) explained in the above embodiment is stored. Moreover, in the hard disk device 209, various kinds of data 212 that is referred to by the program 211 is stored. The input device 202 accepts an input of operation information from an operator. The monitor 203 displays, for example, various kinds of screens operated by an operator. To the interface device 206, for example, a printing device and the like are connected. The communication device 207 is connected to a communication network, such as a local area network (LAN), and communicates various kinds of information with external devices through the communication network.

The CPU 201 reads the program 211 stored in the hard disk device 209, and executes by loading it into the RAM 208, and thereby performs various kinds of processing relating to the functional components described above (for example, the library generating unit 51 and the tool executing unit 52). The program 211 is not necessarily required to be stored in the hard disk device 209. For example, it may be configured to read the program stored in a storage medium that can be read by the computer 200. The storage medium that can be read by the computer 200 corresponds to, for example, a portable recording medium, such as a compact disk read-only memory (CD-ROM), a digital versatile medium (DVD), and a universal serial bus (USB) memory, a semiconductor memory, such as a flash memory, a hard disk drive, and the like. Moreover, it may be configured such that this program 211 is stored in a device connected to a public line, the Internet, a LAN, and the like, and the computer 200 reads the program 211 from these, to execute it.

An increase in the number of simulations for circuit design changes is suppressed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer readable recording medium having stored therein a design supporting program that causes a computer to execute a process comprising:
generating a wiring model in which a gate and a wiring included between registers are replaced with a resistor and a capacitance, and a via that is arranged across wiring layers between the resistors is replaced with a via resistor;
calculating, in the wiring model, a gate delay and a wiring delay for each ratio of the via resistor to the total resistors in a wiring structure between the resistors; and
writing the calculated gate delay and wiring delay of each of the ratio in the wiring model in library information relating to circuit design.

2. The non-transitory computer readable recording medium according to claim 1, further causes the computer to execute the process comprising:
accepting input information relating to a wiring structure to be designed; and
calculating a delay of a wiring structure established based on the accepted input information, based on the library information.

3. The non-transitory computer readable recording medium according to claim 2, wherein
the input information includes an element indicating a transition state of two wirings that are adjacent to each other included in the wiring structure, and
the calculating includes determining a capacitance of the two wirings based on the element.

4. The non-transitory computer readable recording medium according to claim 2, wherein
the writing includes writing discrete values of the gate delay and the wiring delay in the library information, and
the calculating includes calculating the delay based on the discrete values of the gate delay and the wiring delay by linear interpolation.

5. A design supporting method comprising:
generating a wiring model in which a gate and a wiring included between registers are replaced with a resistor and a capacitance, and a via that is arranged across wiring layers between the resistors is replaced with a via resistor, by a processor;
calculating, in the wiring model, a gate delay and a wiring delay for each ratio of the via resistor to the total resistors in a wiring structure between the resistors, by the processor; and
writing the calculated gate delay and wiring delay of each of the ratio in the wiring model in library information relating to circuit design, by the processor.

6. The design supporting method according to claim 5, comprising:
accepting input information relating to a wiring structure to be designed, by the processor; and
calculating a delay of a wiring structure established based on the accepted input information, based on the library information, by the processor.

7. The design supporting method according to claim 6, wherein
the input information includes an element indicating a transition state of two wirings that are adjacent to each other included in the wiring structure, and
the calculating includes determining a capacitance of the two wirings based on the element.

8. The design supporting method according to claim 6, wherein
the writing includes writing discrete values of the gate delay and the wiring delay in the library information, and
the calculating includes calculating the delay based on the discrete values of the gate delay and the wiring delay by linear interpolation.

9. The design supporting apparatus comprising a processor that executes a process comprising:
generating a wiring model in which a gate and a wiring included between registers are replaced with a resistor and a capacitance, and a via that is arranged across wiring layers between the resistors is replaced with a via resistor;
calculating, in the wiring model, a gate delay and a wiring delay for each ratio of the via resistor to the total resistors in a wiring structure between the resistors; and
writing the calculated gate delay and wiring delay of each of the ratio in the wiring model in library information relating to circuit design.

10. The design supporting apparatus according to claim 9, wherein the processor further executes the process comprising:
accepting input information relating to a wiring structure to be designed; and
calculating a delay of a wiring structure established based on the accepted input information, based on the library information.

11. The design supporting apparatus according to claim 10, wherein
the input information includes an element indicating a transition state of two wirings that are adjacent to each other included in the wiring structure, and
the calculating includes determining a capacitance of the two wirings based on the element.

12. The design supporting apparatus according to claim 10, wherein
the writing includes writing discrete values of the gate delay and the wiring delay in the library information, and
the calculating includes calculating the delay based on the discrete values of the gate delay and the wiring delay by linear interpolation.
